(19) United States
(12) Patent Application Publication
(10) Pub. No.: US 2021/0027169 A1
(43) Pub. Date: Jan. 28, 2021

(54) Method for Training Parametric Machine Learning Systems

(71) Applicants: Christopher Kanan, Rochester, NY (US); Tyler Hayes, West Henrietta, NY (US); Kushal Kafle, Rochester, NY (US); Robik Shrestha, Rochester, NY (US)

(72) Inventors: Christopher Kanan, Rochester, NY (US); Tyler Hayes, West Henrietta, NY (US); Kushal Kafle, Rochester, NY (US); Robik Shrestha, Rochester, NY (US)

(73) Assignee: Rochester Institute of Technology, Rochester, NY (US)

(21) Appl. No.: 16/938,035

(22) Filed: Jul. 24, 2020

Related U.S. Application Data
(60) Provisional application No. 62/878,440, filed on Jul. 25, 2019.

(51) Int. Cl. G06N 3/08; G06N 3/04

(52) U.S. Cl. CPC G06N 3/084; G06N 3/0472

(57) ABSTRACT

A system and method for training a parametric machine learning system, include compressing a first data; storing the compressed first data; reconstructing a first selected amount of the stored compressed first data; providing a machine learning system; and training the machine learning system with the reconstructed first data and optionally raw data.

### CROSS REFERENCE

This application claims the benefit of the filing date of U.S. Provisional Patent Application No. 62/878,440, filed Jul. 25, 2019, which is hereby incorporated by reference in its entirety.

This invention was made with government support under grant number W911NF-18-2-0263 awarded by DARPA/ARL; grant number FA9550-18-1-0121 awarded by AFOSR; and grant number 1909696 awarded by the NSF. The government has certain rights in this invention.

### FIELD

The present disclosure relates to a method and system for incrementally training parametric machine learning systems without catastrophic forgetting, and in particular to a method and system for incrementally training parametric machine learning systems without catastrophic forgetting with reconstructed compressed data or a combination of reconstructed compressed data and raw data.

### BACKGROUND

Existing solutions for incremental training of parametric machine learning (ML) models like a convolutional neural network (CNN) have failed to scale. For incremental training of CNNs, most approaches store raw image data, which is not scalable and results in poor performance.

Existing solutions for incremental learning focus on learning in large batches, which is known as incremental batch learning. In incremental batch learning, a learner is given a large batch of data at each time-step, which is looped over until the batch has been learned. After looping through and learning a new batch of data, the agent is then evaluated. This approach to learning is slow since it requires many loops to learn a batch and the agent cannot be evaluated until it has finished learning a batch.

Online streaming learning in a single pass through the dataset is a more realistic scenario where the agent learns one example at a time with a single loop through the entire dataset. Since the agent learns one sample at a time, it can be evaluated immediately, making this learning paradigm more amenable to real-time learning. While there has been work focused on streaming learning in the past, none of the prior works have been able to demonstrate streaming learning for large-scale classification or multimodal tasks.

Existing state-of-the-art methods for incremental learning focus on batch learning using replay. In replay, the models store a subset of previous data and when new data becomes available, they mix the new data with the old data and fine-tune the model on the mixture. By fine-tuning the network on both new and old data, the network learns new information, while not catastrophically forgetting previous knowledge. Furthermore, existing state-of-the-art methods all store raw pixel images for replay, which is memory intensive.

While there is existing work on using vector quantization to store replay data for updating a neural network, these methods operate on vectors only and cannot update convolutional layers of a neural network.

### SUMMARY

In accordance with one aspect of the present invention, there is provided a method for training a parametric machine learning system, including; compressing a first data; storing the compressed first data; reconstructing a first selected amount of the stored compressed first data; providing a machine learning system; and training the machine learning system with the reconstructed first training data.

In accordance with another aspect of the present disclosure, there is provided a parametric machine learning training system including: a compression system which compresses and reconstructs a first data; a memory buffer which stores the compressed first data; a machine learning system; and a computer containing software which trains the machine learning system with the selected stored reconstructed first training data.

These and other aspects of the present disclosure will become apparent upon a review of the following detailed description and the claims appended thereto.

### BRIEF DESCRIPTION OF THE DRAWINGS

FIG. 1 shows a depiction of a step for updating a machine learning system for image classification in accordance with an embodiment of the present invention;

FIG. 2 shows a depiction of a step for updating a machine learning system for a general unimodal problem in accordance with an embodiment of the present invention;

FIG. 3 shows a depiction of a step for updating a machine learning system for a general multimodal problem in accordance with an embodiment of the present invention; and

FIG. 4 shows a depiction of a step for updating a machine learning system for the multimodal visual question answering problem in accordance with an embodiment of the present invention.

### DETAILED DESCRIPTION

The present disclosure relates to a method and system for incrementally training a parametric machine learning system.

The method includes compressing data; storing the compressed data; reconstructing a selected amount of the stored compressed data; providing a machine learning system; and training the machine learning system with the reconstructed data and optionally raw data; and then repeating the procedure with new data. Suitable new data includes reconstructed data, raw data, or a combination thereof. At any time, the method can be trained with either raw data, reconstructed data, or a combination of both types of data.

Data or training data is the set of data that the system learns. Suitable data includes the following modalities: images, strings, audio waves, charts, coordinates, vectors, text, and the like. In an embodiment, the system can perform incremental training of a machine learning system with inputs from several different modalities. When inputs from several different modalities are provided, the raw inputs can either be stored directly (raw) in the memory buffer or the inputs can be compressed and stored in the memory buffer. The method will then obtain and/or reconstruct a selected amount of the stored inputs and combine them with new inputs to train the machine learning system. This procedure can then be repeated for new inputs from several different modalities.

The training data is compressed to encode the training data using fewer bits than the original uncompressed training data representation. Quantization is one example of how compression can be performed. Existing quantization models include Product quantization, K-means clustering, Gaussian mixture models, Vector quantized variational auto-encoders (VQ-VAE), Adaptive Resonance Theory networks, and the like. Other examples of how compression can be performed include transform coding, wavelet compression, Huffman coding, run-length encoding, incremental encoding, and the like.

The compressed data is stored to maintain a copy of the compressed data available for future use. This storage could be done in a memory buffer, an array, a list, or any data structure that allows data to be stored. Suitable components for storage include a CPU or GPU.

Reconstructing the stored compressed data includes selecting a subset of stored compressed data and decoding it such that the decoded data matches the feature space of the original uncompressed data. The selected subset of stored data can include all or a portion of the stored data. To decode the data, a quantization model can be used such as Product quantization, K-means clustering, Gaussian mixture models, Vector quantized variational auto-encoders (VQ-VAE), Adaptive Resonance Theory networks, and the like. Other examples of how decompression can be performed include transform decoding, wavelet decompression, Huffman decoding, run-length decoding, incremental decoding, and the like.

A machine learning system is a system that can be trained on data to learn to perform a task. Suitable tasks include image classification, audio classification, object detection, regression, visual question answering, and the like. Examples of machine learning systems include artificial neural networks, decision trees, support vector machines, Bayesian networks, genetic algorithms, and the like.

The machine learning system can be trained with reconstructed data using a standard update approach. The most common approach for updating neural networks is backpropagation, where errors in the training data are used to update the parameters of the network. Specifically, such standard updates can be obtained through a single update using gradient descent or multiple gradient descent updates. Other update procedures include feedback alignment, direct feedback alignment, and evolutionary algorithms. In some cases, it is also possible to compute an analytic solution for the parameters directly. The machine learning system of the present invention can be described as a mapping from inputs to outputs. The system is said to be trained once this mapping accurately represents the input/output relationship. The fitness of mapping can be defined according to an error function that determines how far the system predictions are from the true predictions or a similar metric.

In an embodiment, the machine learning system can be described as a neural network that is updated in a supervised learning setting using a stochastic gradient descent algorithm in conjunction with backpropagation. As an example, assume the need to update a neural network f with parameters θ on a set of N training examples {(X₁, y₁), (X₂, y₂), . . . , (X_{N}, y_{N})} where Xᵢ is one input data and yᵢ is the associated input label. We define a loss function L(f (Xᵢ; θ), yᵢ) such that our neural network is a function f with parameters θ that takes an input Xᵢ and produces an output y₁′ (i.e., f (Xi; θ)=yi′). The loss function L then computes how far the network prediction yᵢ′ is from the true label yᵢ. To update the network via stochastic gradient descent, the gradient estimate of the loss function with respect to the network parameters θ can be calculated using backpropagation as: g′←1/N ∇_{θ}Σᵢ L(f (Xᵢ; θ), yᵢ). This gradient estimate is then used to update the parameters of the network directly via gradient descent by: θ ←θ−λg′ where θ are the network parameters to be updated, λ is the user-defined learning rate, and g′ is the gradient estimate with respect to the loss function L. This process is then repeated when a new set of inputs is provided to the system.

The machine learning system can be trained with new data including reconstructed compressed data or raw data using a standard updated approach, such as a single update using gradient descent, multiple gradient descent updates, an analytic solution, and the like. The machine learning system can be trained on a combination of reconstructed compressed training data and raw data, this data is first mixed together and then the system is updated on the mixture using a standard update approach, such as a single update using gradient descent, multiple gradient descent updates, an analytic solution, and the like.

To reconstruct a second selected amount of the stored compressed first data the selected amount of stored compressed data is passed through a decoder such that the decoded data matches the feature space of the original data. This decoding can be performed using a quantization model, such as Product quantization, K-means clustering, Gaussian mixture models, Vector quantized variational auto-encoders (VQ-VAE), Adaptive Resonance Theory networks, and the like. Other examples of how decompression can be performed include transform decoding, wavelet decompression, Huffman decoding, run-length decoding, incremental decoding, and the like.

The machine learning system can be trained with the second selected amount of reconstructed first data using a standard update procedure, such as a single update using gradient descent, multiple gradient descent updates, an analytic solution, and the like.

The machine learning system in the present disclosure can be trained in a continuous and/or online manner (e.g., connected to the Internet). This means that the system can be updated on new data sequentially as it becomes available, which could happen within seconds, minutes, days, weeks, and/or years. This is unlike conventional methods for training machine learning systems offline that require all data to be available to the system at once, which is an unrealistic setting. In addition to learning new data continuously, the system in the present disclosure is capable of learning new data without catastrophically forgetting old data. This is an important capability since it allows a machine learning system to be updated over time and dynamically adapt to changes and patterns in new data, while correctly using previous data. Training a system continuously on new data immediately when it becomes available is also faster than training a system offline on both new and old data when the new data becomes available. The present training paradigm is well-suited for real-world machine learning systems that need to learn new things over time and learn these new things immediately when the new data becomes available. Examples of such systems include personal assistants that need to evolve continuously with changes in user's behaviors/preferences, robots that need to learn new skills and tasks over time, face/speech recognition systems that need to adapt to new observations immediately and the like.

In an embodiment, a method for incrementally training a parametric machine learning system includes three phases: base initialization, updating, and inference.

Base initialization includes initializing the parameters of the machine learning system and the compression model. There are multiple ways of initializing the parameters of the machine learning system. The parameters can be trained in a supervised learning manner with a subset of training data or with a different, non-semantically overlapping dataset. The parameters can also be initialized using unsupervised/self-supervised learning techniques such as contrastive learning. Alternatively, the parameters could be initialized with random values or the like. Compression models such as quantization models can be initialized similarly using supervised learning on a subset of the dataset, supervised learning on another non-semantically overlapping dataset, unsupervised/self-supervised learning, random initialization, or the like. Other compression techniques such as transform encoding, wavelet compression, Huffman coding, run-length encoding, or incremental encoding do not need initialization and can be supplied directly.

Updating includes the following steps:

a) receiving one or more input features to be learned (e.g., an audio waveform, an image, a feature vector, and the like);

b) pushing the input through the model to the compression algorithm. Compressing the feature representation. This compression algorithm could be implemented using any compression method, including, but not limited to: Product quantization, K-means, Gaussian mixture model, Vector quantization variational auto encoder (VQ-VAE), and Adaptive Resonance Theory networks. Other compression techniques include transform coding, wavelet compression, Huffman coding, run-length encoding, incremental encoding;

c) storing compressed representation in a buffer;

d) sampling the buffer and combining it with the current examples to be learned; and

e) updating the remainder of the machine learning model using a standard approach. The update may take the form of a single update using gradient descent, multiple gradient descent updates, an analytic solution, and the like; and

f) repeating steps a)-e) when new input data arrives.

Interference includes the following steps:

a) receiving one or more input features to be processed (e.g., an audio waveform, an image, a feature vector, and the like);

b) the model can be run in one of two ways:
i. run the model as usual, no changes are necessary and
ii. run the model but compensate for any decompression errors (e.g., due to reconstruction problems). This could involve fine-tuning the network, error recovery mechanisms, and the like. Subsequently, run the rest of the network; and
c) output the prediction to an electronic storage device, monitor, another program, and the like.

In an embodiment, a system for incrementally training a parametric machine learning system contains the following components: a compression system which compresses and reconstructs data; a memory buffer which stores the compressed data; a machine learning system; and a computer which trains the machine learning system with the reconstructed data.

A compression system is a system that maps a set of values to a smaller set of values, reducing the amount of memory required to store the data. A suitable compression system encodes the original data into a representation that requires fewer bits. The compression system also decodes the encoded representations of the original data back into a representation that exists in the same feature space as the original data. Examples of compression systems include quantization systems such as Product quantization, K-means clustering, Gaussian mixture models, Vector quantized variational auto-encoders (VQ-VAE), Adaptive Resonance Theory networks, and the like. Other examples of compression systems include transform coding, wavelet compression, Huffman coding, run-length encoding, incremental encoding, and the like.

A memory buffer is a data structure that can hold data. Examples of suitable structures include an array or a list. The memory buffer is typically stored on a CPU or GPU, i.e., a computer.

A machine learning system is a system that can be trained on data to learn to perform a task. These tasks include image classification, audio classification, object detection, regression, visual question answering, and the like. Examples of machine learning systems include artificial neural networks, decision trees, support vector machines, Bayesian networks, genetic algorithms, and the like.

The invention can be implemented and executed on any computer, including laptops, desktops, server machines, mobile devices, tablets, embedded devices, and the like. Any device that stores and processes data via instructions from a program is considered to be a computer. The computer can contain a non-transitory computer-readable medium having executable computer program logic embodied therein and a processor configured to execute the computer program logic, including ML algorithms. The device preferably possesses a processor to execute the instructions, a storage system e.g., a solid state drive, to store and retrieve the system and the data, a quick-access memory e.g., random access memory (RAM) to hold the instructions and the data for faster storage and retrieval. Graphics processing units (GPUs) have become increasingly popular in training machine learning systems, and the system can be trained/executed with GPUs. The system can also be trained and executed via other processing units e.g., central processing units (CPUs).

All of the components of the system, including the machine learning system and the compressor/decompressor can be permanently stored in the storage system. Typically, these components are loaded into a faster memory (e.g., RAM) or GPU's internal memory, so that the processor can quickly read instructions from these components to process the data. The data itself can be supplied through input devices (e.g., sensors, cameras) or be read from the storage (e.g., reading images or audio files from a disk). The data is also typically loaded into faster memories for quicker processing. Furthermore, the system is also well-suited for embedded devices with limited memory since it uses compressed representations.

Typically, machine learning (ML) algorithms have distinct train and deployment phases. When new data arrives, the entire model needs to re-learn all of the information it has ever learned. To realize numerous future applications for ML methods, methods for training ML methods incrementally are needed. The present invention is a method for training a parametric machine learning model incrementally, including convolutional neural networks (CNNs). While some previous work has been successful at training models that operate on vectors, methods that operate on tensors or use tensors as internal representations have not been able to scale effectively. This invention addresses this problem and enables incremental training of parametric ML methods, including CNNs. Today, CNNs are the method that powers speech recognition, image classification, and object detection systems. Since 2014, these systems have come into widespread usage, including methods for classifying faces in surveillance systems and social media systems.

For incrementally training convolutional neural network models, prior work has enabled replay by storing raw images. Replay involves mixing old data with new data in order to update the model. The present invention uses tensor quantization, a type of compression, to enable efficient replay with tensors. Unlike prior work, the present method is trained in a streaming manner, meaning it learns one example at a time rather than in large batches containing multiple classes. This method has the potential to scale to far larger datasets. The present method learns instance-by-instance, rather than in batches, more closely matching real-world applications.

This disclosure describes a way of enabling incremental learning for machine learning algorithms that allows the system to continuously learn new material from real time streaming events, without the need to retrain the system from the beginning, a method that is often fraught with inefficiencies and catastrophic forgetting.

The method is used for training parametric machine learning models from individual new pieces of information or batches of new information. By using compression, this method can do this efficiently. This can enable large-scale never-ending learning by algorithms, which is a prerequisite for achieving general artificial intelligence. The present method is a good and scalable solution for arguably one of the most important problems in machine learning.

Applications include updating a toy robot with new information by its user; never-ending learning of information from the web; surveillance by updating a system with new faces immediately; updating an automatic speech recognition system with a new word; and software customization for a user, including home assistants (Google Home, Alexa, etc.).

The publication Hayes, Tyler L., et al. “REMIND Your Neural Network to Prevent Catastrophic Forgetting,” arXiv preprint arXiv: 1910.02509 (2019) discloses systems, methods and procedures for training ML systems and is hereby incorporated by reference herein in its entirety.

The disclosure will be further illustrated with reference to the following specific examples. It is understood that these examples are given by way of illustration and are not meant to limit the disclosure or the claims to follow.

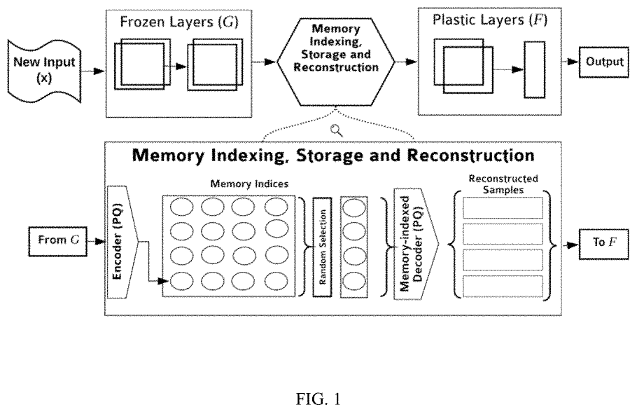

Example 1—Represents a depiction of a step for updating a machine learning system for image classification as shown in FIG. 1.

This example demonstrates that the present system can be used for incremental image classification in which a machine learning system is trained to classify new images over time. This specific instantiation of the disclosed method uses a convolutional neural network model for classification and could be applied to other types of input data including audio waves, feature vectors, strings, and the like. More specifically, as shown in FIG. 1, the convolutional neural network yi=F(G(Xi)) is trained in a streaming paradigm, where Xi is the input image and yi is the predicted output category. The network is composed of two nested functions: G(⋅), parameterized by θG, consists of the first J layers of the CNN and F(⋅), parameterized by θF, consists of the last L layers. θG is kept fixed since early layers of CNNs have been shown to be highly transferable. The later layers, F(⋅), are trained in the streaming paradigm. The output of G(Xi) is a tensor Zi. Using an initial set of data, the outputs of G(⋅) are obtained for this initial set and train a vector (product) quantization model for the Zi tensors. As new training examples are observed incrementally, the quantization model is used to store the Zi features and their labels in a replay buffer as an array of integers. For replay, r instances are uniformly selected from the replay buffer and reconstructed. Each of the reconstructed instances, Zi, are mixed with the current input, and then θF is updated using backpropagation on this set of r+1 instances. During inference, an image is passed through G(⋅), and then the output, Zi, is quantized and reconstructed before being passed to F(⋅).

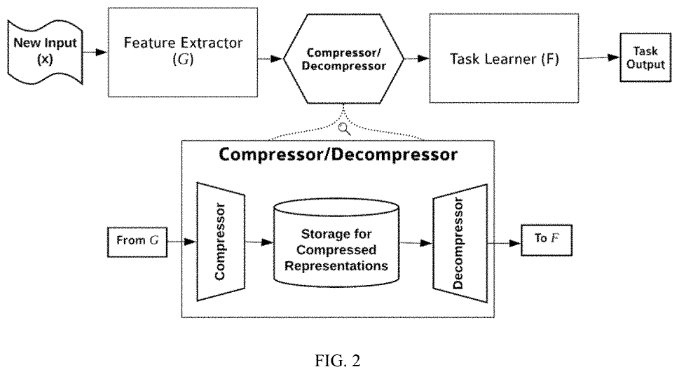

Example 2—Represents a depiction of a step for updating a machine learning system for a general unimodal problem as shown in FIG. 2.

FIG. 2 represents a generic depiction of a method for training a machine learning system incrementally with unimodal inputs. In its simplest form, the machine learning system takes a new input X, which could be an image, a string, a vector, etc., passes the input through a feature extractor (G) to obtain a new representation of X. A compression technique is used to compress the input, which is subsequently stored in storage (e.g., a memory buffer). A decompressor is then used to reconstruct the new input, along with a subset of previous inputs from storage, and this mixture of decompressed inputs is then used to update the task learner (F), before an output is given by the system. This procedure is then repeated for new inputs. Unimodal inputs including images, audio waves, charts, strings, or the like can be used in this method. The feature extractor G could be a convolutional neural network, a dimensionality reduction technique, or the like. The compressor component could be implemented using a quantization model, transform coding, wavelet compression, Huffman coding, run-length encoding, incremental encoding, and the like. The decompressor component would be the associated decoding component for the selected compressor component. The task learner F could be a convolutional neural network, a decision tree, a support vector machine, a Bayesian network, or any other classification model.

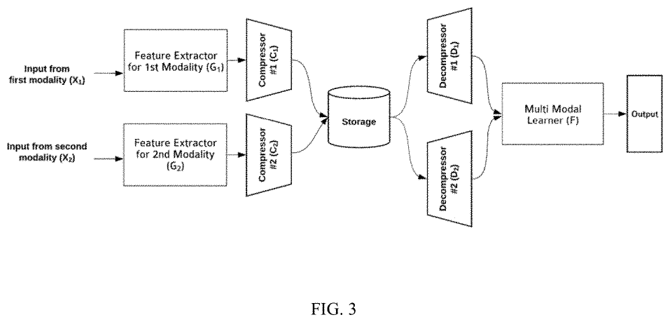

Example 3—Represents a depiction of a step for updating a machine learning system for a general multimodal problem as shown in FIG. 3.

The system enables multimodal learning. In multimodal learning, agents must learn from multiple types of inputs e.g., combination of visual and textual data or combination of textual and auditory data. Examples of such tasks include visual question answering, image captioning, referring expressions recognition, visual query detection, object detection and the like. During training, each of these tasks are composed of several separate, but related, inputs. Examples of specific inputs include: an image and an associated question/caption string for visual question answering/visual captioning or an image and an associated set of bounding boxes for object detection.

Formally, during training, a streaming multimodal machine learning system receives a sequence of temporally ordered inputs from N modalities: D={(X1, X2, X3, . . . , XN, y)} at each time-step, where X1 is the input to be compressed such as an image, a feature vector, an audio wave, etc., X2, X3, X_{N} are extra inputs that will either be stored explicitly or compressed in a similar way as X1, and y is the associated output. FIG. 3 is a depiction of a generic multimodal system to be trained incrementally having two related inputs. Specifically, the system takes in two inputs from two modalities (N=2): X1 and X2. These inputs are processed by feature extractors from their respective modalities: G1 and G2 to yield new representations. Representations from both modalities are compressed using modality-specific compressors: C1 and C2. Based on the application, it may be desirable to not compress inputs from certain modalities, which is also supported by the present methods. The resulting representations are stored in a storage. Modality-specific decompressor(s): D1 and D2 are then used to reconstruct inputs from multiple modalities, which are mixed with new multimodal observations to train the task learner (F).

The individual modalities may correspond to visual, textual, auditory, and other signals, and the feature extractors are chosen based on the type of modality. For example, convolutional neural networks can be employed for visual input and recurrent neural networks for textual inputs. A different decompression technique can be employed for each modality if desired.

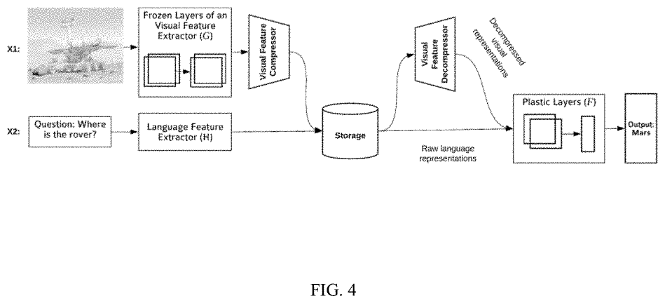

Example 4—Represents a depiction of a step for updating a machine learning system for the multimodal visual question answering problem as shown in FIG. 4.

For the incremental visual question answering system depicted in FIG. 4, a new input pair will be input into the model (X1, X2) at time t, where X1 is an image and X2 is an associated question string about the image. The visual input (X1) can be passed through a visual feature extractor (G) to obtain a tensor that can be compressed using the visual feature compressor and stored in memory. The question string input (X2) can be passed through a language feature extractor (H) (e.g., recurrent neural network or a transformer network) to obtain a new feature to be stored directly in memory (without compression or decompression). The visual decoder can then reconstruct a subset of previous inputs. The associated question strings will be paired up with the reconstructed inputs and these pairs will be used to train the plastic layers of the network (F). This procedure is then repeated for new inputs.

Although various embodiments have been depicted and described in detail herein, it will be apparent to those skilled in the relevant art that various modifications, additions, substitutions, and the like can be made without departing from the spirit of the disclosure and these are therefore considered to be within the scope of the disclosure as defined in the claims which follow.

What is claimed:

1. A method for training a parametric machine learning system, comprising;
compressing a first data;
storing the compressed first data;
reconstructing a first selected amount of the stored compressed first data;
providing a machine learning system; and
training the machine learning system with the reconstructed first data.

2. The method of claim 1, further comprising training the machine learning system with raw data.

3. The method of claim 1, further comprising training the machine learning system with data comprising reconstructions of compressed second data, raw data, or both.

4. The method of claim 3, further comprising reconstructing a second selected amount of the stored compressed first data and training the machine learning system with the second selected amount of reconstructed first data.

5. The method of claim 1, wherein the first selected amount of the stored compressed first data comprises all the stored compressed first data.

6. The method of claim 1, wherein data comprises images, strings, audio waves, charts, coordinates, vectors, or text.

7. The method of claim 1, wherein compressing a first data is performed by a compression model.

8. The method of claim 7, wherein the compression model is a product quantization, K-means clustering, Gaussian mixture model, vector quantized variational auto-encoder (VQ-VAE), or Adaptive Resonance Theory network, transform coding, wavelet compression, Huffman coding, run-length encoding, or incremental encoding.

9. The method of claim 1, wherein the machine learning system is an artificial neural network, decision tree, support vector machine, Bayesian network, or genetic algorithm.

10. The method of claim 1, wherein the machine learning system is trained to learn to perform a task comprising image classification, audio classification, object detection, regression, visual question answering, and combinations thereof.

11. The method of claim 1, wherein the data comprises at least two different modalities.

12. The method of claim 1, wherein the data comprises at least two of images, strings, audio waves, charts, coordinates, vectors, and text.

13. The method of claim 1, wherein the training is performed in a continuous or online manner.

14. A parametric machine learning training system comprising:
a compression system which compresses and reconstructs a first data;
a memory buffer which stores the compressed first data;
a machine learning system; and
a computer which trains the machine learning system with the selected stored reconstructed first data.

15. The parametric machine learning training system of claim 14, wherein the compression system is a product quantization, K-means clustering, Gaussian mixture model, vector quantized variational auto-encoder (VQ-VAE), or Adaptive Resonance Theory network, transform coding, wavelet compression, Huffman coding, run-length encoding, or incremental encoding.

16. The parametric machine learning training system of claim 14, wherein the memory buffer is an array or a list.

17. The parametric machine learning training system of claim 14, wherein the machine learning system is an artificial neural network, decision tree, support vector machine, Bayesian network, or genetic algorithm.

18. The parametric machine learning training system of claim 14, wherein the data comprises images, strings, audio waves, charts, coordinates, vectors, or text.

19. The parametric machine learning training system of claim 14, wherein the data comprises at least two different modalities.

20. The parametric machine learning training system of claim 14, wherein the data comprises at least two of images, strings, audio waves, charts, coordinates, vectors, and text.
